(19) United States
(12) Patent Application Publication
(10) Pub. No.: US 2017/0083292 A1
(43) Pub. Date: Mar. 23, 2017

(54) VISUAL CONTENT DEVELOPMENT

(71) Applicant: Amazon Technologies, Inc., Seattle, WA (US)

(72) Inventors: Colin McLaughlan, Seattle, WA (US); Preston Alan Tamkin, Seattle, WA (US); Jonathan Michael Henson, Seattle, WA (US)

(21) Appl. No.: 14/859,177

(22) Filed: Sep. 18, 2015

(51) Int. Cl. G06F 9/44; G06F 3/0484

(52) U.S. Cl. CPC G06F 8/34; G06F 3/0484

(57) ABSTRACT

Techniques for developing software applications that call a virtualized computing environment are described. A graphical user interface is rendered that is operable to graphically depict a representation of an input, output, and operation based on user input data. Graphical depictions of the representation of the input, output, and operation are rendered. The rendered graphical depictions are associated with related executable code operable to execute functionality implementing the input, output, and operation and call services in the virtualized computing environment.

### BACKGROUND

A service provider, such as an entity that operates a provider network, may offer computing resources, such as computing instances and storage resources to clients. The service provider may, for example, provide a computing and network services platform. Multiple clients may access the computing and network services platform via a computing node and issue instructions to the web services platform. The computing and network services platform may be also be referred to as a multi-tenant computing and network services platform to denote that multiple clients may access the platform.

Many multi-tenant computing and network services platforms provide virtualized resources and web-based tools or applications that users can access and use through a web browser as if the virtualized resources were programs installed locally on their own computers. The data stored for users of such systems are typically hosted in computing systems located in a computing data center. In some examples, electronically presented content, such as multi-player games, may be simultaneously accessed and engaged by large numbers of different users. To make their content readily available to users, content developers of such content are often forced to become experts in server deployment and management technologies.

### BRIEF DESCRIPTION OF DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced.

FIG. 1 illustrates an example of a high-level system diagram of a system for content development, in accordance with some aspects of the disclosure.

FIG. 2 illustrates an example of translation of visual script, in accordance with some aspects of the disclosure.

FIG. 3 illustrates an example of a high-level system diagram of a visual development environment, in accordance with some aspects of the disclosure.

FIG. 4 illustrates an example of a functional block diagram of a content development environment, in accordance with some aspects of the disclosure.

FIG. 5 is an example of a functional block diagram of a content development environment, in accordance with some aspects of the disclosure.

FIG. 6 illustrates an example user interface for creating/editing content, in accordance with some aspects of the disclosure.

FIG. 7 illustrates an example user interface for creating/editing content, in accordance with some aspects of the disclosure.

FIG. 8 illustrates an example user interface for creating/editing content, in accordance with some aspects of the disclosure.

FIG. 9 illustrates an example of an operational procedure for developing content.

FIG. 10 is a block diagram depicting an embodiment of a computing environment in which aspects of the present disclosure may be practiced.

FIG. 11 is a block diagram depicting an embodiment of a computing system on which aspects of the present disclosure may be practiced.

### DETAILED DESCRIPTION

Users of a multi-tenant computing and network services platform may develop and publish applications on the platform. In many cases, the users may have to estimate the numbers and configurations of resources and resource types to best suit the user's application development and deployment needs according to the technical specifications of the resources and resource types. Furthermore, the users are often required to learn and apply specific languages, procedures, and other technical details in order to properly configure servers, storage devices, and other resources in order to begin development and deployment activities. However, not all users may have sufficient information or experience to accurately estimate the numbers and configurations of resources that are required to meet their needs. Nor are all users willing to invest time and resources to learn the specific languages and procedures required to access these resources.

The present disclosure describes a development environment where aspects of the process of developing and deploying a software application may be provided by an integrated development and deployment environment. The development and deployment environment may execute on a developer computing system, and/or may execute on the multi-tenant computing and network services platform (also referred to as a provider network) and may be accessible via remote access technologies using a web browser interface. The disclosure describes systems and methods for an application development environment for creating content of all types. Specifically, systems, and methods are described for providing a virtual project environment where content can be created, constructed, programmed, and/or edited in a visual environment that does not require specific knowledge of programming languages or processes and procedures for accessing the underlying resources of the provider network that may be accessed when desired applications are implemented and published.

In some embodiments, the visual development environment allows developers to generate code that calls and accesses various services at the provider network using a visual scripting paradigm. The visual development environment may host, for example, programming logic components that persist between user sessions. The user may use the visual scripting paradigm to develop applications, thus avoiding the need to learn client-server programming and other specific methodologies for accessing the services available at the provider network. Once the code that calls and accesses various services at the provider network has been generated, that code can be integrated into, or combined with, other code used for implementing numerous kinds of software applications, such as virtualized content and video games. In addition, an entire software application may be created using the visual scripting paradigm, such that all of the code for the software application is generated using the visual development environment.

In some embodiments, the visual development environment may be configured to generate code that integrates backend services of the provider network with visual tools and templates that can be extended to meet the needs of developers. Templates may be used as starting points by developers to create and manage a collection of building blocks for applications and functions. Additionally, the templates may include complete samples of entire applications and other content.

By using visual building blocks for application development that may be translated to code that correspond to actions for provider network services, developers can access the functionality of the provider network services without requiring the use of specific interfaces for each of the services, requiring the developers to learn the specific programming details of each of the services, or requiring the developers to write code in languages such as C++, providing an ease of use for developers to access the utilize the provider network services. Developers may create application stacks and machine images to deploy desired online services by only using graphical tools of the visual development environment. For example, visual development environment may be used to generate functionality for keeping track of player global state and inventory between game sessions, relative rankings between all players of a game, and providing trading services between players. Thus a developer may be able to script the desired gameplay and publish the result for access to users, without having to know about how to define specific technical requirements for servers and other computing resources.

The building blocks that may be selected using the visual development environment may be associated with instructions and other actionable inputs that can generate actions implemented on various backend services of the provider network, such as file storage, content distribution, database access, cloud computing functions, workflow services, server fleet management and scaling, and scalable server side events. The implemented actions may be generated without having to directly build and manage software stacks, server machine images, and security settings. For example, developers may be able to use change notifications combined with API calls to register and respond to changing user inputs in an application such as player data in a video game application. In addition, developers may be able to use the visual development environment to generate code that directs a server fleet to automatically scale based on performance and demand (e.g., auto-scaling). Furthermore, developers may be able to script server side logic in a scalable manner so that the developer or sponsor of the project will only be charged for actual usage of computing resources.

In some embodiments, the visual development environment may execute on the developer's systems. The visual development environment may be used to generate code that executes on user computers and calls services of the provider network. In other embodiments, the visual development environment may execute on the provider network and/or any combination of these or other systems and networks. The visual development environment may be accessible to developers via interfaces such as a web browser interface. The visual development environment executing on the provider network may be used by developers to generate code that executes on user computers and calls services of the provider network. In further embodiments, the generated code may execute on the provider network and may be accessible to end users via interfaces such as a web browser interface.

It should be appreciated that although the embodiments disclosed in this disclosure discuss the visual development environment in the context of video game development, other types of applications can be developed with the concepts and technologies disclosed herein. For example, the embodiments disclosed herein might also be utilized with applications that provide content delivery services.

In some embodiments, the visual development environment may also allow developers to customize selected features using non-visual and traditional development tools. For example, a developer may us the visual development environment to generate code. The developer may be provided with the ability to access the generate code and make modifications to the generated code using non-visual methods such as direct text coding.

In some embodiments, content may be created by developers using the visual development environment, which in turn is integrated with various backend and other services or components that may host or otherwise interact with deployed instances of the content. The content may include a distributed application, such as an application relying at least partially on network-based services (e.g., auto-scaling), virtualized online content, data and record management, collaborative editing tools, or a multiplayer video game. In some embodiments, a web-based user interface providing one or more options for accessing the visual development environment may be presented to a developer user of the provider network. The visual development environment, via the user interface, may receive inputs to a content development project, and can also access other information such as the edit history for a particular user. Alternatively, software implementing the functionality of the visual development environment may be downloaded to a computing system of the developer and may execute locally.

In some embodiments, various functional modules may be exposed in a visual editor of the visual development environment. The visual editor may render graphical depictions of inputs, operations on the inputs, and outputs of the operations and/or depictions of a representation of the inputs, operations, and outputs. The graphical depictions may then be associated with related instructions that can be used to launch and control various backend services. In one embodiment, the graphical depictions may be translated or scripted into corresponding instructions that can be executed on various backend services. For example, the graphical depictions may be translated to JavaScript that can be uploaded directly to server side functions at the provider network. Furthermore, the visual development environment may script code that executes on the end user's computing device, as well as code that executes in the computing environment of the provider network.

The visual development environment may be integrated with various backend services that are selected based on computing services that are relevant to various application development needs. For example, online games typically access services for storing data, sharing data, applying structure to data, and execute computations on data. In some embodiments, backend services may include a storage service that allows for creating, reading, writing, and modifying of data. Storage services may allow for information created on a client and uploaded to a server. The uploaded information may be processed and decisions made, with the changed states written back to a client. Storage services may also allow for user-generated content that can be uploaded by users and shared with other users within the context of the application. For example, a user may capture a screenshot or video pertaining to a game application and upload the data for sharing with others users. As another example, game data may be recorded and uploaded for other users to later download as challenges to the video game.

A content delivery service may be provided that allows developers to serve data in an efficient manner to users and provide content protection and rights management. For example, data content may be stored in selected servers that are physically located closer to expected user locations, allowing for lower latency for content delivery. In addition, selected content can be associated with access keys to allow for delivery of content based on permissions or purchases.

A database service may be provided that allows structure to be applied to the application data. For example, data sets may be the created and maintained for tracking persistent states of game data for both player and non-player characters. Server side services may be provided for computations and other operations to be applied to data based on changes detected in the storage and/or database services. For example, server-side scripts and logic may be triggered based on new data being written to data storage, or based on monitoring specified data streams. The visual development environment may be integrated with additional provider network services.

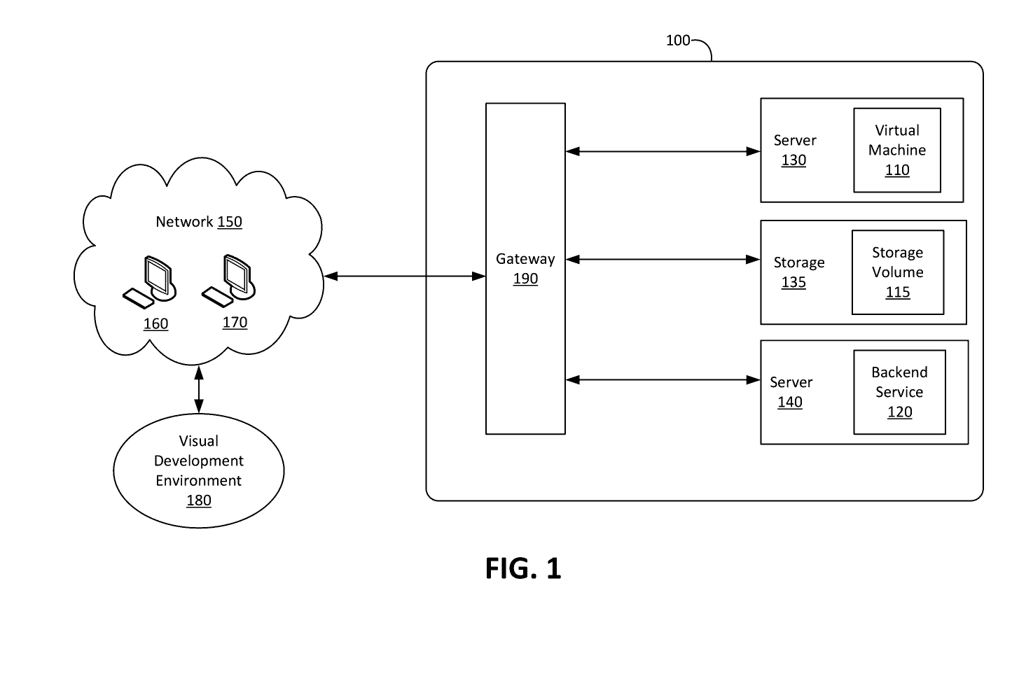

FIG. 1 is a diagram illustrating a system 100 including a framework for providing a visual development environment in accordance with the present disclosure. In FIG. 1, system 100 may include a virtual machine resource 110, storage volume resource 115, and a backend 120 that may execute, for example, on one or more server computers 130 and 140 and storage volume 135. It will be appreciated that some embodiments may involve additional resources of various types that may be instantiated on additional server computers.

FIG. 1 also illustrates a public network 150 that may include one or more computers, such as computers 160 and 170. According to one embodiment, resources 110, 115 and 120 may be configured to provide computing services to a computer user (not shown) of public network 150 via gateway 190 and computers 160 and 170. For example, virtual machine resource 110 may provide a set of remote access enterprise applications to a group of users. The resources may be implemented as virtual machine instances, storage resources, and other types of computing resources.

In one embodiment, computer 160 or 170 may access or execute a visual development environment 180 for launching or editing an application. For example, the visual development environment 180 may be implemented at least in part by a software application that is downloaded at computer 160 or 170. In other embodiments, visual development environment 180 may be hosted by the data center 100 and a user operating at computer 160 or 170 may access the visual development environment 180 by sending a request to access visual development environment 180. The request may be received directly from the user at computer 160 or 170. In response to receipt of a request, visual development environment 180 may log the request and respond to the request. The visual development environment 180 may communicate with other services of the provider network, if necessary, to facilitate: (1) processing of the request, (1) bidding for resources to fulfill the request, and (3) allocation of resources necessary to fulfill the request. The visual development environment 180 may, for example, provide an interface for facilitating instantiation of the request and generating a visual interface for launching or editing the application. The visual development environment 180 may further provide an interface for viewing the status of the request and modifying or cancelling the request, as well as other user interfaces that may be used for editing the application. In some embodiments, user interface depictions may be generated by the service provider and sent to the user's display for rendering. In other embodiments, the user's computing device may include functionality to generate some or all portions of the user interface. For example, if the user's web browser may include code for generating some of the graphics for rendering data received from the service provider.

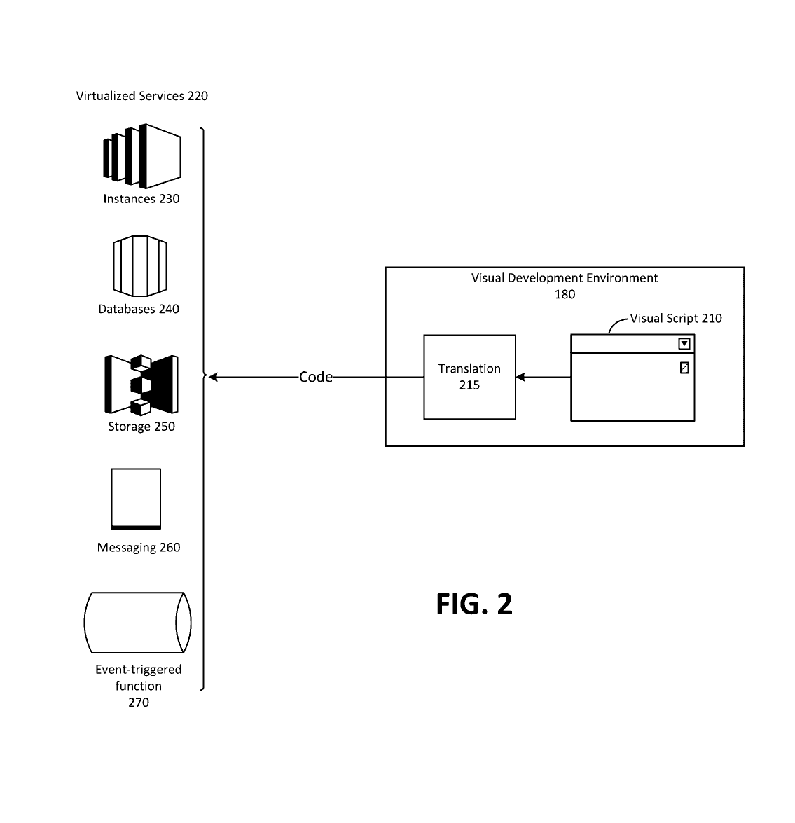

FIG. 2 depicts a block diagram illustrating an example of visual development environment 180 and generation of code that calls and/or controls services at a provider network. Visual development environment 180 may be configured to translate data representative of a visual script 210. The visual script 210 may be edited using various software and/or hardware components that render a graphical depiction of the functionality of the content on a user computing device and allow the user to interact with and change the content. The visual script 210 may be received via the software and/or hardware mechanisms.

The visual script 210 may include information representing one or more functions that are graphically depicted on a user interface. In one embodiment, the visual script 210 may include data representing a number of functions or methods that further include at least one input and at least one output. For example, the graphical depictions may include a block representation of a function or operation that may be performed on an input data item such as a data file. Graphical depictions may also include a representation of inputs to the function or operation, as well as outputs from the function or operation. The inputs and outputs may be represented, for example, using line connectors such as arrows that may be manipulated to depict the source of an input and the destination of an output.

The visual script 210 will typically include multiple block representations and input/output representations to allow for graphical manipulation of relationships and data flows. The depicted user interface may allow for the visual script 210 to be edited using typical drag and drop and other interactive mechanisms that may be typical of user interface tools using a keyboard, mouse, touchscreen, and other input devices.

The visual script 210 may be translated using a translation component 215. In one embodiment, the translation component 215 may be configured to access a database of code elements and map the representation of visual script 210 to one or more of the code elements. The mapping may be performed based on which function or operation is depicted in the visual script 210. For example, a pattern classification system may be used to identify relevant code elements based on the visual script 210. The pattern classification system may encode relationships that map which code elements are relevant to a selected function or operation. The pattern classification system may be programmed to identify which functions or operations map to a particular code element. The pattern classification system may also be updated as new code elements are added. In some embodiments, the pattern classification system may include a learning function to continuously learn which code elements are relevant to a selected function or operation. The learning system may then classify future observations into categories of code elements that may be created from the earlier mappings.

The translation component 215 may also be configured to receive the representation of the visual script 210, parse the representation, and convert the parsed representation to a set of instructions. The conversion may be implemented using the pattern classification system described above, or may be based on a series of instructions that may be encoded based on known relationships between the parsed representations and corresponding code elements.

The mapped or generated code may be operable to interact with and control various virtualized services 220 that may be provided by a provider network. The mapped or generated code may include, for example, instructions that launch or access services such as virtualized instances 230 for configuring and launching virtual machines, database services 240 for applying structure to application data, storage services 250 for creating, reading, writing, and modifying of data, messaging services 260 for pushing notifications to users, and event-driven function for triggering provider network services based on events. The services may include others that are not illustrated in FIG. 2, but may be provided on the provider network.

For example, visual script 210 may represent a desired operation such as retrieval of a value from a key value store. The visual script may include a name of an input that represents the key and an output that represents the output value from the key value retrieval. The visual script 210 may thus include an input arrow including a text string indicating the key name variable, and an output arrow with a text string indicating the output variable. Visual script 210 in this example may comprise a box indicating a key value retrieval function with two ports. Translation component 215 may receive data indicative of the visual script 210 and generate code that defines a class that inherits functionality defined by the visual development environment 180 that includes an input name string, output name string, and input index. Translation component 215 may further generate a function that includes a call to a database service at the provider network, access to a database including a database identifier and value information, and returning of a value. The code may further include instructions for receiving the returned value and providing the returned value to the output indicated by the visual script 210.

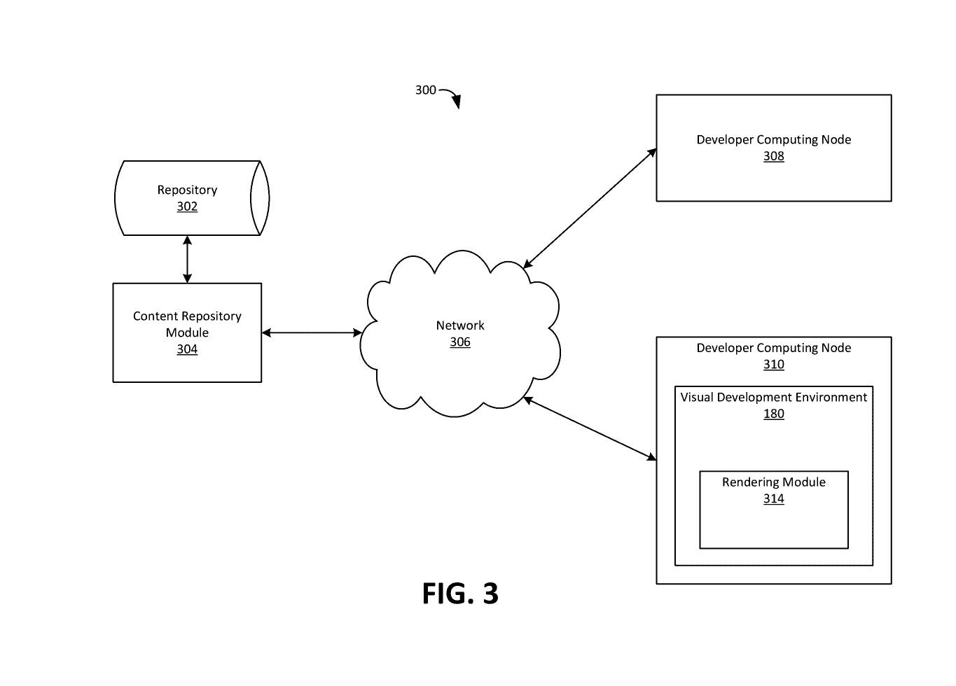

FIG. 3 is a block diagram depicting an example of a visual editing system 300 that may be used in conjunction with visual development environment 180. Visual editing function 300 may comprise a number of developer computing nodes, such as those depicted in FIG. 3 as development computing node 308 and development computing node 310 that are configured with software and/or hardware providing mechanisms for creating, editing, and testing applications and other content. Content may include interactive content, such as a software application, an interactive video, and the like. Developer computing node 310 may execute visual development environment 180. Visual development environment 180 may include a rendering module 314 that is configured to interact with user interface components of the development computing node 308. A developer component of the rendering module 314 may be configured to present options on the user interface for uploading content to be edited and to add one or more interactive components to the content.

Using the visual development environment 180, content such as an application may be edited using a graphical depiction of the functionality of the content on the developer computing node 308 or 310 and allow the developer to interact with and change the content. Elements of the content, including those that do not normally involve a visual component, may be represented on a user interface by a graphical element. This allows each element of the content to be easily selected for further editing. Rendering module 314 may be configured to render views of the building blocks of the content that is being developed. The rendering module 314 may be configured to render the graphical elements that make up the content. The rendering module 314 may render the graphical elements to include various visual indications, such as inputs, outputs, operations, methods, and the like. The visual development environment 180 may contain additional modules for editing properties of the content, creating new content, deleting unwanted content, and so on.

The visual development environment 180 on developer computing node 308 or 310 may allow changes to content made locally, on developer computing node 308 or 310, to be transmitted over network 306 to a content repository module 304 for storage in a repository 303. The information may be transmitted on a continuous basis, or on demand based on the request of a user. In some cases, server 310 may include software and/or hardware other than or in addition to an integrated development environment. For example, developer computing node 308 or 310 may also be configured to function as a test platform for the content being developed.

Network 306 may comprise various means of communicating between computing nodes. Examples include local area networks, the Internet, and so forth. Both wired and wireless networks may be employed, in various combinations.

The content repository module 304 may comprise software and/or hardware related to maintenance of repository 303. The content repository module 304 may receive information from the developer computing node 308 or 310 that describes changes made to content of the content, including the data for the content. The content repository module 304 may also receive and process requests to change the status of content in the repository.

The content repository module 304 may maintain versions of content as well as an indication of which version currently being edited. The data may be stored as a log-type structure within repository 303. The repository 303 may comprise a storage device, such as a solid-state drive, on which the structure may be maintained. The content repository module 304 may employ various conflict detection, avoidance, and recovery mechanisms to protect consistency of the content.

The content repository module 304 may perform commit and rollback operations on unsaved changes. The rendering module 314 may be configured generate views of the content that utilize visual indications of content that have been stored in repository 303, and which have been described by transmissions received from content repository module 304.

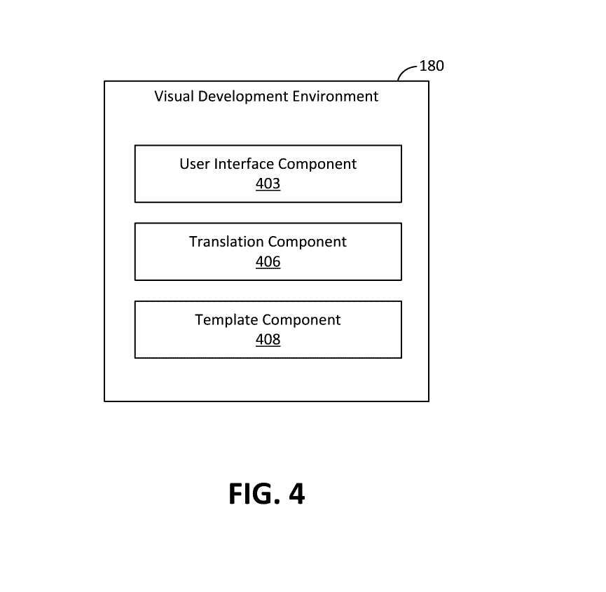

FIG. 4 is a functional block diagram depicting visual development environment 180 in greater detail. Visual development environment 180 may include a user interface component 404. User interface component 404 may be configured to present one or more user interfaces enabling users, such as developers, to create content, view content, interact with content, and/or other actions.

User interface component 404 may also be configured to provide a visual editing interface control, which may facilitate the construction of application data, logic, or any other editing related task. In some aspects, the user interface component 404 may provide a default editor that provides a core set of action objects that can be extended, modified, and used together to define a content project. For example, the user interface component 404 may provide an interface for users to create content, such as, for example, an application or interactive video. User interface component 404 may be configured to present options for uploading content to be edited and to add one or more components to the content.

In addition, visual development environment 180 may include a translation component 406 for associating input data with related instructions and other actionable objects that are operable to execute on computing services executing in the provider network. A template component 408 may also be provided for providing templates and other reusable information for use by developers. Templates may be used as starting points by developers to create and manage content and update the content in an orderly and predictable fashion. By using templates to create identical copies of the same project or as a foundation for starting a new project, developers may develop applications predictably and repeatedly without spending considerable effort creating and configuring the underlying structures associated with their projects. Furthermore, the developers may use the templates as is or use the templates as a starting point for creating the developers' own templates.

In one embodiment, the user interface component 404 may allow developers to select resources, inputs, outputs, values, interconnections, and other parameters. Furthermore, the developer may be provided a user interface for creating a new project. The developer may select or create a template that defines an initial set of variables and actions. For example, the developer may select a template that the developer wants to use. The user interface may provide sample templates for popular applications that the developer can deploy to get started. For example, sample templates may be provided that can show a developer how to interconnect and use multiple resources for a particular video game type. A developer may also load the developer's own custom templates that may have been previously created and stored using service provider storage or the customer's own storage. The developer may customize a template by overriding template parameters, or the developer may accept the default values supplied by the template. The template component 408 may create the desired content.

The template component 408 may allow a developer to request a template for a recommended application starting point based on the developer's requirements. A developer may, for example, provide requirements for a new computing project. The template component 408 may analyze the requirements and, based on existing templates and other information, the template component 408 may generate one or more recommended templates. The recommended templates may be prioritized and ranked based on the customer's requirements or other criteria. The developer may select one of the recommended templates for generation of a project.

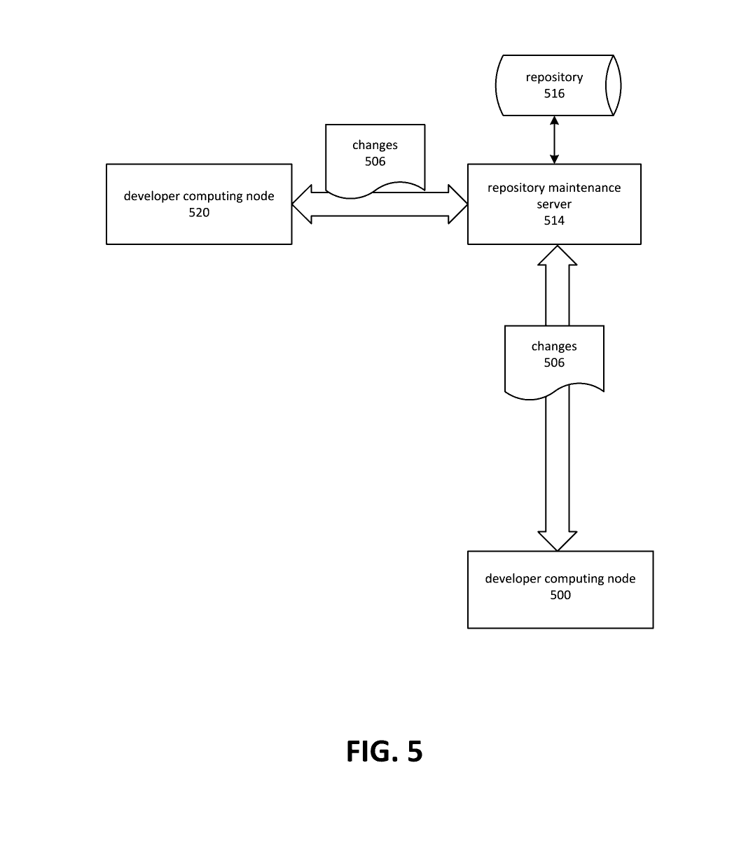

FIG. 5 is a block diagram depicting data flow between multiple developer computing nodes and repository maintenance server 515. A developer computing node 500 may generate data indicative of updates to a project, while a client 520 may also generate data indicated of updates to the project. Repository maintenance server 514 may transmit the same set of information regarding the updates to both of clients 500 and 520. Because the information is shared by both client 500 and client 520, they may each render views of the content that are indicative of work being done by the users corresponding to clients 500 and 520. In some embodiments, data may be transmitted and disseminated on a continuous basis as changes are submitted to repository maintenance server 514 and stored in repository 516. In other embodiments, the visual development environment 180 may store changes on a periodic basis or upon request. Once submitted, repository maintenance server 514 may disseminate the information to all developer computing nodes known to be working on the project.

Visual development environment 180 may include development tools that, in some embodiments, may include a set of software libraries and tools that a developer may use to construct additional configuration data that defines an application as well as additional developer tools that might be configured to allow editing of the application's data.

In one embodiment, the action objects may be digital objects that contain programming logic and/or data that define a behavior and can invoke other action objects or communicate to the application cluster. The programming logic can be further defined as any form of scripting or programming language constructed through the use of software libraries provided with the development tools.

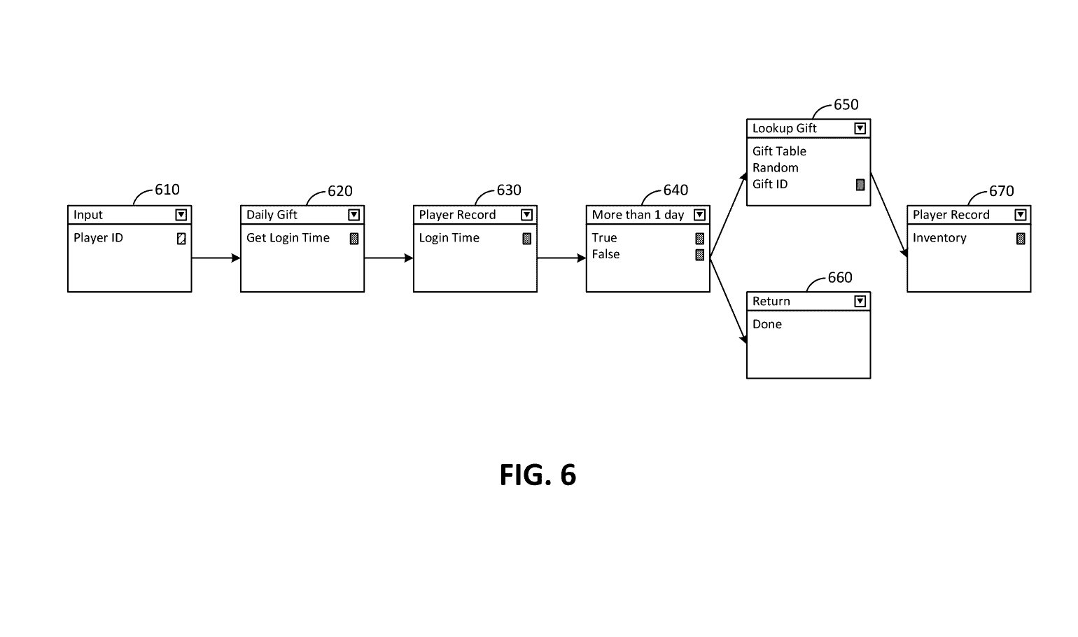

FIGS. 6-8 illustrate a series of example user interface displays that may be presented on developer computing node 310 for editing content. The interface displays may be generated by the visual development environment 180 (shown in FIG. 1). The visual development environment 180 may include a computer-readable medium that comprises code segments or sections for, when executed on a computer, carrying out the methods described herein.

As illustrated in FIG. 6, after accessing (e.g., logging into) the visual development environment 180, for example via the user interface component 403, and selecting an option to create a new project, an empty project may be loaded. The empty project may include an option to select content from a content list. The content list may be provided as a drop-down list, a menu list, and the like. The content list may comprise content previously uploaded by the user or by another user who has made the content available. In some aspects, an option may be presented for the user to upload new content.

As shown in FIG. 6, project component 610 indicates a first graphical component indicating name Input and player ID, with an arrow indicating a relationship to project component 620. Project component 620 indicates a second graphical component indicating a corresponding name Daily Gift and method Get Login Time, with an arrow indicating a relationship to project component 630. Project component 630 indicates a third graphical component indicating a corresponding name Player Record and variable Login Time, with an arrow indicating a relationship to project component 640. Project component 640 indicates a fourth graphical component indicating a corresponding name More than 1 day, with an arrow indicating a relationship to project component 650 and 660. Finally, project component 670 indicates a final graphical component indicating a corresponding name Player Record and Inventory.

In one embodiment, the graphical components may be selectable on a rendered user interface by a user input means such as a mouse controlling a pointer. By selecting a graphical component such as project component 610, a user may be able to move the project component 610 on a rendered user interface to a desired location. The user may also be able to select an arrow or other connector and attach the selected connector to another project component such as project component 620. The connector thus represents an output of project component 610 and an input to project component 620.

The operations performed by a project component may be selected from a list of available and selectable operations, or may be defined by the user. For example, if a user selects a project component, the user may also be presented with a context menu that includes selectable operations. Alternatively, the user may be presented with an input field for entry of a user-defined operation. Other input mechanisms may be provided to select or define an operation for a project component.

The graphical components may be represented in the visual development environment 180 as sets of ordered relationships. For example, connectors between project components may be represented as related data objects. Project components may be represented as one or more operation or function names or definitions. The visual development environment 180 may define a standardized nomenclature for representing graphical components. The representations may then be translated or mapped to operations at the provider network to generate code that can interact with services at the provider network.

The graphical components may be associated with code that implements actionable inputs that can generate actions implemented on various backend services of the provider network, such as file storage, content distribution, database access, cloud computing functions, workflow services, server fleet management and scaling, and scalable server side events. The implemented actions may be generated without having to directly build and manage software stacks, server machine images, and security settings. For example, the graphical components may be associated with code that interacts with a storage service that allows for creating, reading, writing, and modifying of data, or a database service may be provided that allows structure to be applied to the application data.

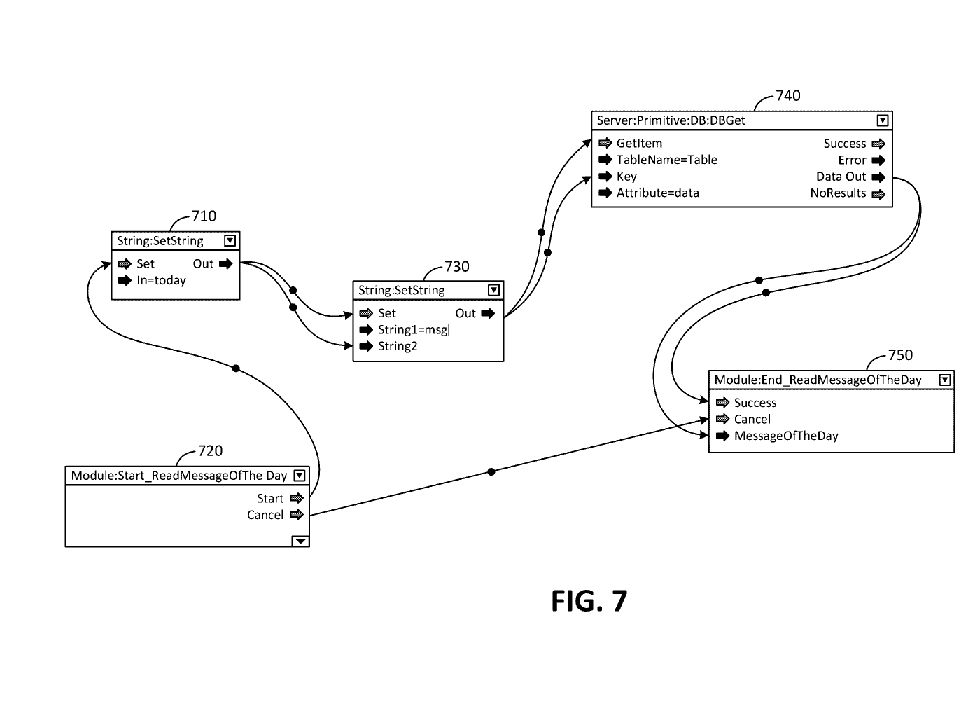

FIG. 7 illustrates another example of a screen display after particular content (e.g., an application) has been selected. When content has been loaded, project components 710, 720, 730, 740, and 750 may be rendered. Each graphical component indicates a corresponding input and method including one or more specified actions, with arrows indicating corresponding relationships to related components. By using the illustrated graphical depictions of actionable components, developers may generate desired functionality for applications by specifying objects and variables without having to use languages and functions specific to the underlying backend services. As illustrated in FIG. 7, multiple arrows or connectors may be used to indicate relationships between components involving a plurality of data interactions. For example, project component 710 is shown as proving two output interactions with project component 730. Additional, project component 720 is shown as proving two output interactions with project components 710 and 750. The example shown in FIG. 7 illustrates project components that may be used to access a database service at the provider network in which a message string is retrieved and returned to an end-user device for display. Each of the project components may represent a logical element with a user-defined number of inputs and outputs. If an input is defined, then a value or an event may be received on the input. If an output of one project component is connected to the input of another project component, then the output may activate the input of the other project component.

Project component 720 may represent a start of the function that sets a parameter of “today” as input to project component 710. Project component 710 outputs the set parameter to project component 730 that further sets objects “string1” and “string 2.” Project component 740 receives the outputs from project component 730 to generate an access to the database services of the provider network with an identified table name. Project component 740 also sets a key value for access to the value for the message that will be returned by project component 740 to project component 750 including indication of a successful database access and the text string for the “message of the day” object for display.

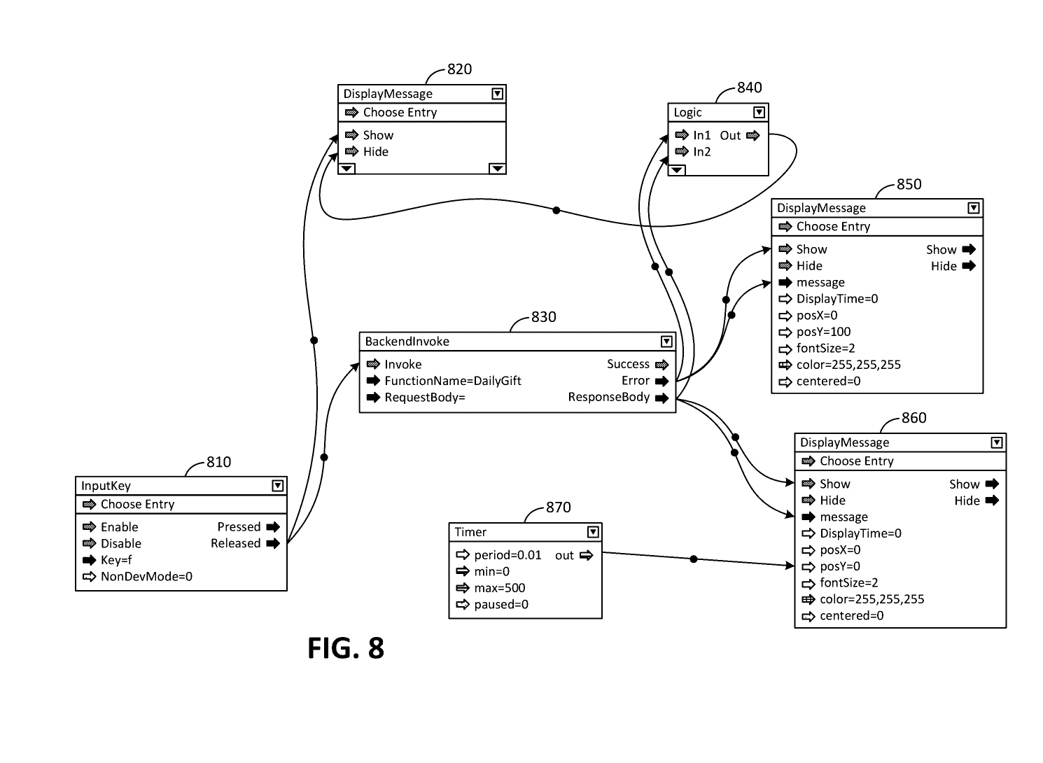

FIG. 8 illustrates another example of a screen display after particular content (e.g., an application) has been selected. When content has been loaded, project components 806, 810, 820, 830, 840, 860, 860, and 870 are rendered. Each graphical component indicates a corresponding input and method including one or more specified actions, with arrows indicating corresponding relationships to related components. As shown, multiple arrows may be used to indicate relationships between components involving a plurality of data interactions. Furthermore, project components may be populated with multiple operations. Additionally, as shown by project component 860, project components may be connected to and interact with multiple input operations or output operations. The example of FIG. 8 includes functionality that invokes server side logic to send an incentive or reward to a user of a game application. Project component 810 may represent a start of the function based on receiving of an input key that outputs to project component 830 when a pressed key is released. Project component 830 invokes function “BackendInvoke” to call a server function at the provider network that invokes function “DailyGift.” Project component 810 also sends the released key status to the “DisplayMessage” project component 820 to display a “Choose Entry” display function. Project component 830 sends outputs of the “DailyGift” function to “DisplayMessage” functions depicted as project components 850 and 860. Project component 850 receives an error output message from project component 830, which is displayed at Y position 100. Otherwise, project component 860 receives input “ResponseBody” which is displayed at Y position 0. The depicted project components may be associated with code that implements the described functionality either on code that is run locally on the end-user device, or code that accesses or invokes actions implemented on various backend services of the provider network, such as file storage, content distribution, database access, and scalable server side events.

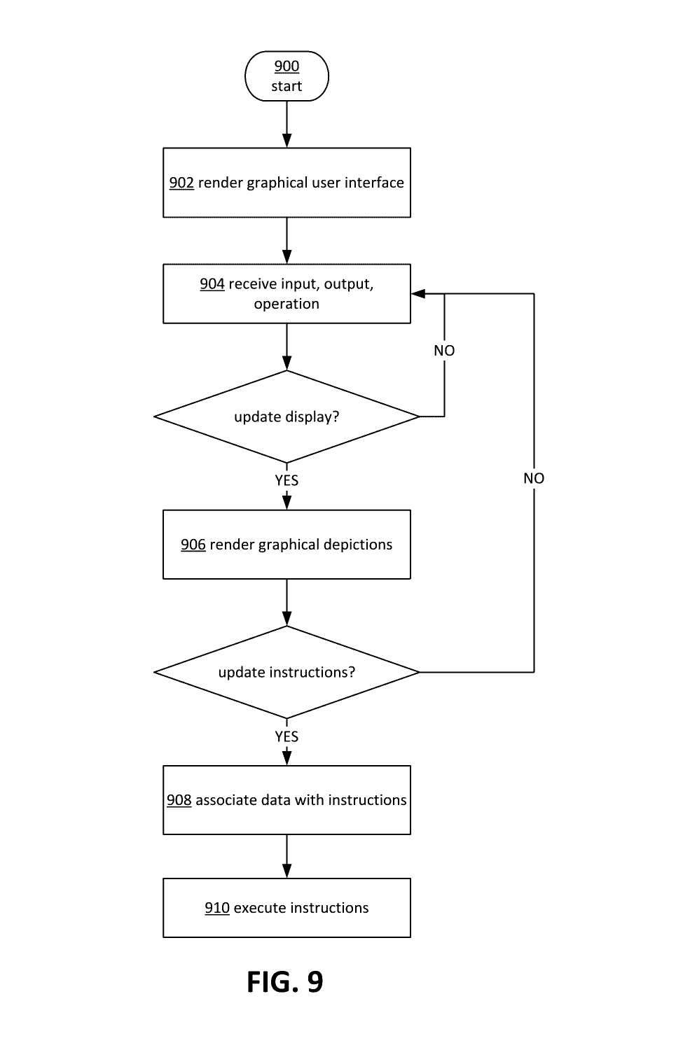

FIG. 9 illustrates an example of an operational procedure for developing a software application in a virtualized computing environment. In one embodiment, the operational procedure may be implemented in a virtualized computing environment hosted by a multi-user computing and network services platform. Referring to FIG. 9, the operational procedure may include operations 902, 904, 906, 908, and 910. Operation 900 begins the operational procedure. Operation 900 may be followed by operation 902. Operation 902 illustrates rendering a graphical user interface depicting an interactive environment for developing a software function. The software function may be operable to call the virtualized computing environment. In some embodiments, the graphical user interface is operable to at least graphically depict an input, output, and operation and/or depictions of a representation of the input, output, and operation. For example, the graphical user interface may include a visual editing interface control operative to facilitate construction of the input, output, and operation.

Operation 902 may be followed by operation 904. Operation 904 illustrates receiving, via the graphical user interface, data indicative of the input, output, and operation. If the current display is to be updated, based on a change in input by the developer, for example, then operation 904 may be followed by operation 906. Operation 906 illustrates based at least in part on the data, rendering graphical depictions of the input, output, and operation.

If the developer inputs additional changes and an update to current instructions are needed, then operation 906 may be followed by operation 908. Operation 908 illustrates in response to receiving the data, associating the data with related instructions that are operable to call computing services executing in the virtualized computing environment. In some examples, operation 908 may include translating the data to related instructions that are operable to execute on computing services executing in the virtualized computing environment. The related instructions may comprise programming logic of a software development project. The instructions may comprise code or script that is operable to interact with services of the virtualized computing environment. The instructions may be predefined and in some embodiments may be implemented as data objects. The predefined data objects may be made accessible as templates that can be used to initiate or populate a software development project.

In some embodiments, the instructions may be operable to call functions that create, read, write, and modify data file storage in a virtualized data storage service of the virtualized computing environment. The virtualized data storage service may allow for information generated by a user device to be uploaded and stored in the virtualized data storage service. The virtualized data storage service may also allow for the user-generated content to be shared with other users within the context of the application.

In some embodiments, the instructions may be operable to call functions that are configured to transfer data from the virtualized data storage service to selected servers or computing instances of the virtualized computing environment. For example, user-generated content may be stored in selected servers that are physically located closer to expected user locations, allowing for lower latency for delivery of the user-generated content

In some embodiments, the instructions may be operable to interact with a database of the virtualized computing environment for storage of application data sets. For example, application data sets may be the created and maintained for tracking persistent states of application data for application end-users.

In some embodiments, the instructions may be operable to call functions of the virtualized computing environment based on selected events. For example, server-side services may be provided for computations and other operations to be applied to data based on changes detected in the storage and/or database services. In some embodiments, server-side scripts and logic may be triggered based on new data being written to data storage, or based on monitoring of specified data streams. The selected events include one or more of a file upload, application activities, input device actions, or output from a device.

In some embodiments, the instructions may be operable to call functions that interact with a messaging service. For example, electronic or SMS messages may be automatically sent to an identified user or to large numbers of recipients. Messages may also be sent to other services of the virtualized computing environment.

In some embodiments, the instructions may be operable to call functions that interact with an identity management and data synchronization service that may be configured to control access to provider network services and resources by end-users, and to synchronize data on multiple devices and resources where the data is to be stored. The instructions may also be operable to call functions that establish security and authentication to allow or deny to the provider network services and resources by the end-users.

Operation 908 may be followed by operation 910. Operation 910 illustrates generating the related instructions to effect functionality represented by the graphically depicted input, output, and operation and call the computing services. The generated instructions may be executed, for example, by the end user systems. At least some of the described operations including the rendering of the graphical user interface, receiving of data indicative of the input, output, and operation, rendering of the graphical depictions, associating the data with related instructions, generating, and executing the related instructions may be performed on a developer computing device or may be performed on the virtualized computing environment.

In some embodiments, an application programming interface (API) may be provided to facilitate user input of data indicative of the inputs, outputs, and operations. For example, an API can be called with information such as a content or project identifier and data indicative of the inputs, outputs, and operations. After the API is called, a service such as the visual development environment 180 may take actions such as:
Parse the data indicative of the inputs, outputs, and operations,
Access a database of predetermined data objects comprising translated code,
Perform a mapping of the parsed data to the predetermined data objects,
Invoke a translation function.

The visual development environment 180 may report the results of the mapping or translation through the API along with other details regarding the resulting code.

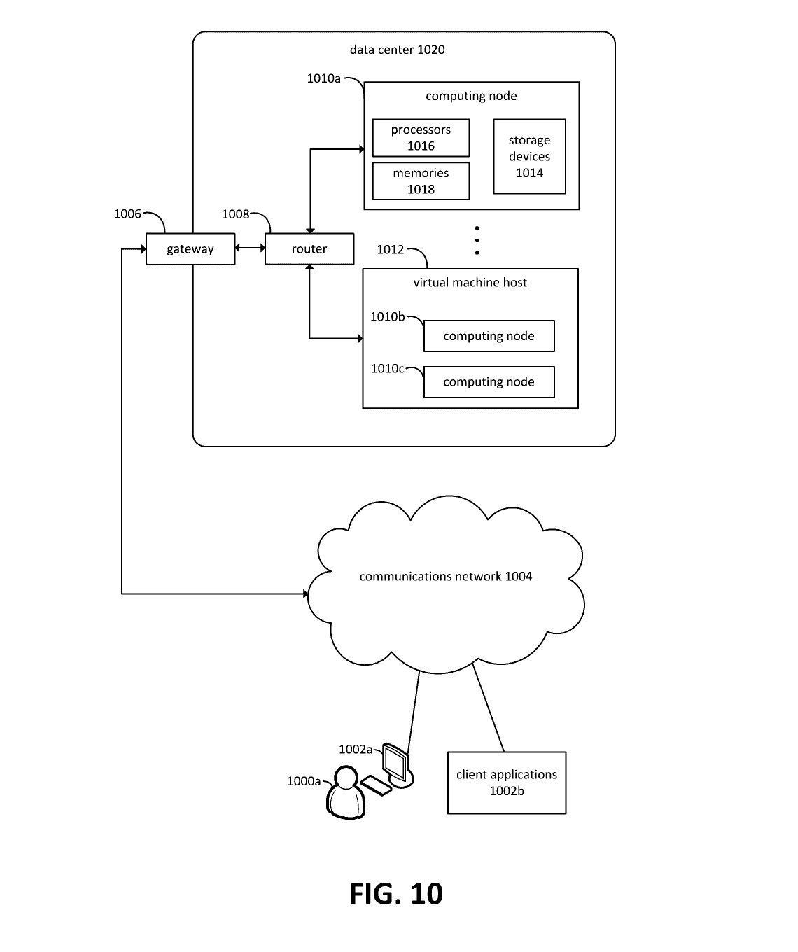

FIG. 10 is a diagram depicting an example of a distributed computing environment on which aspects of the present invention may be practiced. Various users 1000a may interact with various client applications, operating on any type of computing device 1002a, to communicate over communications network 1004 with processes executing on various computing nodes 1010a, 1010b, and 1010c within a data center 1020. Alternatively, client applications 1002b may communicate without user intervention. Communications network 1004 may comprise any combination of communications technology, including the Internet, wired and wireless local area networks, fiber optic networks, satellite communications, and so forth. Any number of networking protocols may be employed.

Communication with processes executing on the computing nodes 1010a, 1010b, and 1010c, operating within data center 1020, may be provided via gateway 1006 and router 1008. Numerous other network configurations may also be employed. Although not explicitly depicted in FIG. 10, various authentication mechanisms, web service layers, business objects, or other intermediate layers may be provided to mediate communication with the processes executing on computing nodes 1010a, 1010b, and 1010c. Some of these intermediate layers may themselves comprise processes executing on one or more of the computing nodes. Computing nodes 1010a, 1010b, and 1010c, and processes executing thereon, may also communicate with each other via router 1008. Alternatively, separate communication paths may be employed. In some embodiments, data center 1020 may be configured to communicate with additional data centers, such that the computing nodes and processes executing thereon may communicate with computing nodes and processes operating within other data centers.

Computing node 1010a is depicted as residing on physical hardware comprising one or more processors 1016, one or more memories 1018, and one or more storage devices 1014. Processes on computing node 1010a may execute in conjunction with an operating system or alternatively may execute as a bare-metal process that directly interacts with physical resources, such as processors 1016, memories 1018, or storage devices 1014.

Computing nodes 1010b and 1010c are depicted as operating on virtual machine host 1012, which may provide shared access to various physical resources, such as physical processors, memory, and storage devices. Any number of virtualization mechanisms might be employed to host the computing nodes.

The various computing nodes depicted in FIG. 10 may be configured to host web services, database management systems, business objects, monitoring and diagnostic facilities, and so forth. A computing node may refer to various types of computing resources, such as personal computers, servers, clustered computing devices, and so forth. A computing node may, for example, refer to various computing devices, such as cell phones, smartphones, tablets, embedded device, and so on. When implemented in hardware form, computing nodes are generally associated with one or more memories configured to store computer-readable instructions and one or more processors configured to read and execute the instructions. A hardware-based computing node may also comprise one or more storage devices, network interfaces, communications buses, user interface devices, and so forth. Computing nodes also encompass virtualized computing resources, such as virtual machines implemented with or without a hypervisor, virtualized bare-metal environments, and so forth. A virtualization-based computing node may have virtualized access to hardware resources as well as non-virtualized access. The computing node may be configured to execute an operating system as well as one or more application programs. In some embodiments, a computing node might also comprise bare-metal application programs.

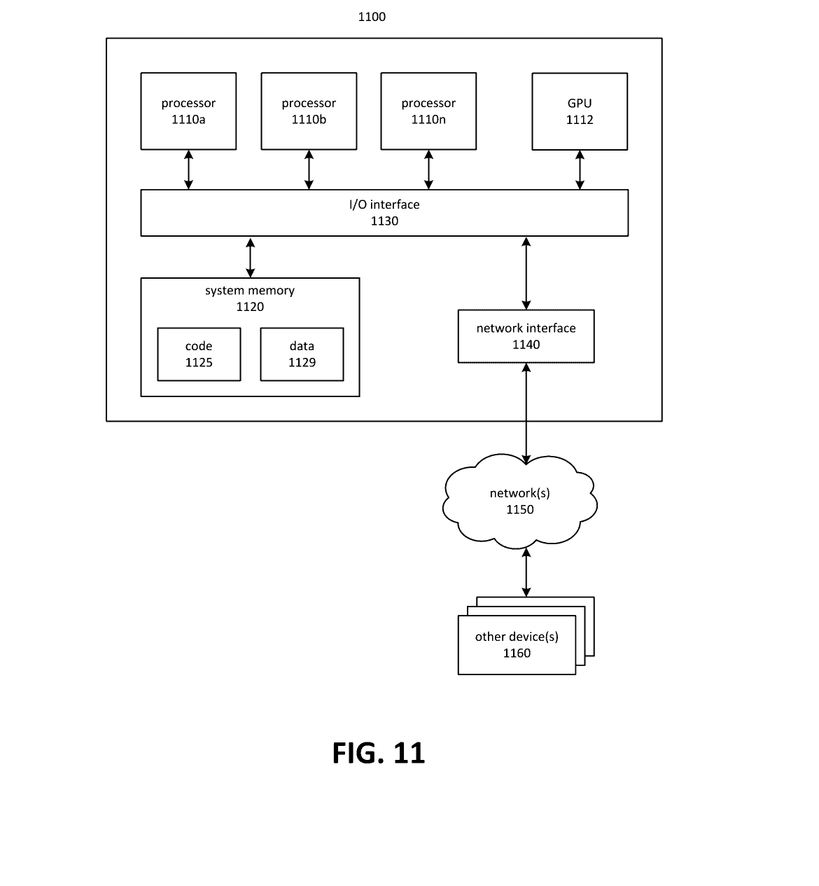

In at least some embodiments, a server that implements a portion or all of one or more of the technologies described herein may include a computer system that includes or is configured to access one or more computer-accessible media. FIG. 11 depicts a computer system that includes or is configured to access one or more computer-accessible media. In the illustrated embodiment, computing device 1100 includes one or more processors 1110a, 1110b, and/or 1110n (which may be referred herein singularly as a processor 1110 or in the plural as the processors 1110) coupled to a system memory 1120 via an input/output (“I/O”) interface 1130. Computing device 1100 further includes a network interface 1140 coupled to I/O interface 1130.

In various embodiments, computing device 1100 may be a uniprocessor system including one processor 1110 or a multiprocessor system including several processors 1110 (e.g., two, four, eight, or another suitable number). Processors 1110 may be any suitable processors capable of executing instructions. For example, in various embodiments, processors 1110 may be general-purpose or embedded processors implementing any of a variety of instruction set architectures (“ISAs”), such as the x811, PowerPC, SPARC or MIPS ISAs, or any other suitable ISA. In multiprocessor systems, each of processors 1110 may commonly, but not necessarily, implement the same ISA.

In some embodiments, a graphics processing unit (“GPU”) 1112 may participate in providing graphics rendering and/or physics processing capabilities. A GPU may, for example, comprise a highly parallelized processor architecture specialized for graphical computations. In some embodiments, processors 1110 and GPU 1112 may be implemented as one or more of the same type of device.

System memory 1120 may be configured to store instructions and data accessible by processor(s) 1110. In various embodiments, system memory 1120 may be implemented using any suitable memory technology, such as static random access memory (“SRAM”), synchronous dynamic RAM (“SDRAM”), nonvolatile/Flash®-type memory, or any other type of memory. In the illustrated embodiment, program instructions and data implementing one or more desired functions, such as those methods, techniques, and data described above, are shown stored within system memory 1120 as code 1126 and data 1129.

In one embodiment, I/O interface 1130 may be configured to coordinate I/O traffic between processor 1110, system memory 1120, and any peripherals in the device, including network interface 1140 or other peripheral interfaces. In some embodiments, I/O interface 1130 may perform any necessary protocol, timing or other data transformations to convert data signals from one component (e.g., system memory 1120) into a format suitable for use by another component (e.g., processor 1110). In some embodiments, I/O interface 1130 may include support for devices attached through various types of peripheral buses, such as a variant of the Peripheral Component Interconnect (“PCI”) bus standard or the Universal Serial Bus (“USB”) standard, for example. In some embodiments, the function of I/O interface 1130 may be split into two or more separate components, such as a north bridge and a south bridge, for example. Also, in some embodiments some or all of the functionality of I/O interface 1130, such as an interface to system memory 1120, may be incorporated directly into processor 1110.

Network interface 1140 may be configured to allow data to be exchanged between computing device 1100 and other device or devices 1160 attached to a network or networks 1160, such as other computer systems or devices, for example. In various embodiments, network interface 1140 may support communication via any suitable wired or wireless general data networks, such as types of Ethernet networks, for example. Additionally, network interface 1140 may support communication via telecommunications/telephony networks, such as analog voice networks or digital fiber communications networks, via storage area networks, such as Fibre Channel SANs (storage area networks), or via any other suitable type of network and/or protocol.

In some embodiments, system memory 1120 may be one embodiment of a computer-accessible medium configured to store program instructions and data as described above for implementing embodiments of the corresponding methods and apparatus. However, in other embodiments, program instructions and/or data may be received, sent, or stored upon different types of computer-accessible media. Generally speaking, a computer-accessible medium may include non-transitory storage media or memory media, such as magnetic or optical media, e.g., disk or DVD/CD coupled to computing device 1100 via I/O interface 1130. A non-transitory computer-accessible storage medium may also include any volatile or non-volatile media, such as RAM (e.g., SDRAM, DDR SDRAM, RDRAM, SRAM, etc.), ROM, etc., that may be included in some embodiments of computing device 1100 as system memory 1120 or another type of memory. Further, a computer-accessible medium may include transmission media or signals, such as electrical, electromagnetic or digital signals, conveyed via a communication medium, such as a network and/or a wireless link, such as those that may be implemented via network interface 1140. Portions or all of multiple computing devices, such as those illustrated in FIG. 11, may be used to implement the described functionality in various embodiments; for example, software components running on a variety of different devices and servers may collaborate to provide the functionality. In some embodiments, portions of the described functionality may be implemented using storage devices, network devices or computer systems. The term “computing device,” as used herein, refers to at least all these types of devices and is not limited to these types of devices.

A compute node, which may be referred to also as a computing node, may be implemented on a wide variety of computing environments, such as tablet computers, personal computers, smartphones, game consoles, commodity-hardware computers, virtual machines, web services, computing clusters, and computing appliances. Any of these computing devices or environments may, for convenience, be described as compute nodes or as computing nodes.

A network set up by an entity, such as a company or a public sector organization, to provide one or more web services (such as various types of cloud-based computing or storage) accessible via the Internet and/or other networks to a distributed set of clients may be termed a provider network. Such a provider network may include numerous data centers hosting various resource pools, such as collections of physical and/or virtualized computer servers, storage devices, networking equipment, and the like, needed to implement and distribute the infrastructure and web services offered by the provider network. The resources may in some embodiments be offered to clients in various units related to the web service, such as an amount of storage capacity for storage, processing capability for processing, as instances, as sets of related services, and the like. A virtual computing instance may, for example, comprise one or more servers with a specified computational capacity (which may be specified by indicating the type and number of CPUs, the main memory size, and so on) and a specified software stack (e.g., a particular version of an operating system, which may in turn run on top of a hypervisor).

A number of different types of computing devices may be used singly or in combination to implement the resources of the provider network in different embodiments, including computer servers, storage devices, network devices, and the like. In some embodiments a client or user may be provided direct access to a resource instance, e.g., by giving a user an administrator login and password. In other embodiments the provider network operator may allow clients to specify execution requirements for specified client applications and schedule execution of the applications on behalf of the client on execution platforms (such as application server instances, Java™ virtual machines (“JVMs”), general-purpose or special-purpose operating systems, platforms that support various interpreted or compiled programming languages, such as Ruby, Perl, Python, C, C++, and the like, or high-performance computing platforms) suitable for the applications, without, for example, requiring the client to access an instance or an execution platform directly. A given execution platform may utilize one or more resource instances in some implementations; in other implementations multiple execution platforms may be mapped to a single resource instance.

In many environments, operators of provider networks that implement different types of virtualized computing, storage and/or other network-accessible functionality may allow customers to reserve or purchase access to resources in various resource acquisition modes. The computing resource provider may provide facilities for customers to select and launch the desired computing resources, deploy application components to the computing resources, and maintain an application executing in the environment. In addition, the computing resource provider may provide further facilities for the customer to quickly and easily scale up or scale down the numbers and types of resources allocated to the application, either manually or through automatic scaling, as demand for or capacity requirements of the application change. The computing resources provided by the computing resource provider may be made available in discrete units, which may be referred to as instances. An instance may represent a physical server hardware platform, a virtual machine instance executing on a server, or some combination of the two. Various types and configurations of instances may be made available, including different sizes of resources executing different operating systems (OS) and/or hypervisors, and with various installed software applications, runtimes, and the like. Instances may further be available in specific availability zones, representing a logical region, a fault tolerant region, a data center, or other geographic location of the underlying computing hardware, for example. Instances may be copied within an availability zone or across availability zones to improve the redundancy of the instance, and instances may be migrated within a particular availability zone or across availability zones. As one example, the latency for client communications with a particular server in an availability zone may be less than the latency for client communications with a different server. As such, an instance may be migrated from the higher latency server to the lower latency server to improve the overall client experience.

In some embodiments the provider network may be organized into a plurality of geographical regions, and each region may include one or more availability zones. An availability zone (which may also be referred to as an availability container) in turn may comprise one or more distinct locations or data centers, configured in such a way that the resources in a given availability zone may be isolated or insulated from failures in other availability zones. That is, a failure in one availability zone may not be expected to result in a failure in any other availability zone. Thus, the availability profile of a resource instance is intended to be independent of the availability profile of a resource instance in a different availability zone. Clients may be able to protect their applications from failures at a single location by launching multiple application instances in respective availability zones. At the same time, in some implementations inexpensive and low latency network connectivity may be provided between resource instances that reside within the same geographical region (and network transmissions between resources of the same availability zone may be even faster).

Each of the processes, methods, and algorithms described in the preceding sections may be embodied in, and fully or partially automated by, code modules executed by one or more computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage, such as, e.g., volatile or non-volatile storage.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments.

It will also be appreciated that various items are illustrated as being stored in memory or on storage while being used, and that these items or portions thereof may be transferred between memory and other storage devices for purposes of memory management and data integrity. Alternatively, in other embodiments some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

What is claimed is:

1. A computer-implemented method for developing a software application that interacts with a virtualized computing environment hosted by a multi-tenant computing services platform, the method comprising:
rendering a graphical user interface depicting an interactive environment for developing instructions that are operable to call computing services executing in the virtualized computing environment, wherein the graphical user interface is operable to at least graphically depict a representation of an input, output, and operation associated with the computing services executing in the virtualized computing environment;
receiving, via the graphical user interface, data indicative of the input, output, and operation;
based at least in part on the data, rendering graphical depictions of the representation of the input, output, and operation;
associating the data with instructions that are operable to call computing services executing in the virtualized computing environment; and
generating the instructions associated with the representation that when executed effect functionality represented by the representation and call the computing services executing in the virtualized computing environment.

2. The method of claim 1, wherein the graphical user interface includes a visual editing interface control operative to facilitate construction of the representation of the input, output, and operation.

3. The method of claim 1, wherein the instructions are included in programming logic of a software application.

4. The method of claim 1, wherein the rendering the graphical user interface, receiving, rendering the graphical depictions, and associating are performed on a developer computing device or the virtualized computing environment.

5. The method of claim 3, wherein the software application is a video game.

6. A system configured to develop and deploy an application that interacts with a virtualized computing environment hosted by a multi-tenant computing services platform, the system comprising at least one memory having stored therein computer instructions that, upon execution by one or more processors of the system, at least cause the system to:
depict an interactive environment for developing a function that is operable to call the virtualized computing environment; and
graphically depict representations of at least one operation of the function; and
access a plurality of data objects associated with services provided by virtualized computing environment and usable to implement the function; and
generate, using the plurality of predefined data objects, code operable to implement the function and call services of the virtualized computing environment.

7. The system of claim 6, wherein the graphical user interface includes a visual editing interface control.

8. The system of claim 6, wherein the code persists between user sessions.

9. The system of claim 6, wherein the data objects include templates.

10. The system of claim 6, wherein the code is operable to call functions that create, read, write, and modify data file storage in a virtualized data storage service.

11. The system of claim 6, wherein the code is operable to call functions that receive user data, store the user data, process operations on the user data, and send changed states to a user device.

12. The system of claim 10, wherein the code is operable to call functions that transfer data from the virtualized data storage service to servers.

13. The system of claim 6, wherein the code is operable to interact with a database of the virtualized computing environment for storage of application data.

14. The system of claim 6, wherein the code is operable to call functions of the virtualized computing environment based on selected events.

15. The system of claim 14, wherein the selected events include one or more of a file upload, application activities, input device actions, or output from a device.

16. The system of claim 6, wherein the code is operable to call functions that interact with a messaging service.

17. The system of claim 6, wherein the code is operable to call functions that interact with an identity management service.

18. A non-transitory computer-readable storage medium having stored thereon computer-readable instructions that upon execution on one or more computing devices, at least cause the one or more computing devices to:
render a graphical user interface operable to graphically depict a representation of an input, output, and operation based at least in part on user input data;
based at least in part on the user input data, render graphical depictions of the representation of the input, output, and operation;
associate the rendered graphical depictions with executable code operable to execute functionality implementing the input, output, and operation and call services in the virtualized multi-tenant computing environment; and
generating the executable code, wherein execute the executable code causes the functionality implementing the input, output, and operation represented by the graphical depictions and calls the services.

19. The computer-readable storage medium of claim 18, further comprising computer-readable instructions that upon execution on one or more computing devices, at least cause the one or more computing devices to implement an application programming interface configured to:
receive first electronic messages that encode identifiers indicative of the user input data; and
in response to receiving one of the first electronic messages, send second electronic messages indicative of the executable code.

20. The computer-readable storage medium of claim 18, wherein the executable code is operable to control computing services hosted on the virtualized multi-tenant computing environment.
